(19) United States
(12) Patent Application Publication
(10) Pub. No.: US 2013/0292974 A1
(43) Pub. Date: Nov. 7, 2013

(54) COVER FOR WHEELCHAIR AND METHOD OF USE

(71) Applicants: Sharon Pausell, Columbia, MO (US); Steve Paulsell, Columbia, MO (US)

(72) Inventors: Sharon Pausell, Columbia, MO (US); Steve Paulsell, Columbia, MO (US)

(21) Appl. No.: 13/859,700

(22) Filed: Apr. 9, 2013

Related U.S. Application Data
(60) Provisional application No. 61/622,205, filed on Apr. 10, 2012.

(51) Int. Cl. A61G 5/10

(52) U.S. Cl. CPC A61G 5/10
USPC 297/188.01; 297/219.1

(57) ABSTRACT

An apparatus is disclosed that combines with a wheelchair to decorate and individualize the wheelchair. The apparatus has a balance of features that reduce cost and deliver optimal benefits to the user. A method of using the apparatus is also disclosed.

### FIELD OF INVENTION

Embodiments of the current invention relate to the mechanical arts and more specifically, consumer products.

### BACKGROUND OF INVENTION

The invention is an improvement upon the current state of the art in wheelchair coverings. Wheelchairs have been used for decades in hospitals, nursing homes and in homes for personal use. Wheelchairs are very limited in variety, colors and are typically not considered attractive by users. Additionally, in situations where there are multiple wheelchair users (such as on Honor Flights which take World War II veterans to Washington D.C. to see memorials) it can be difficult for wheelchair users to identify their particular wheelchair because most wheelchairs are very similar in appearance. Therefore, it is desirable for wheelchair users to have a decorative covering on the back that will allow for improved aesthetics, personalization and identification of a user's wheelchair. Additionally, a wheelchair cover that allows business, healthcare facilities, wheelchair sports teams, etc. to personalize their wheelchairs, extends their ability to display marketing, branding, public interest and team messages. The current state of the art does not have a suitable, simple cover to achieve these purposes.

U.S. Pat. No. 7,278,649 discloses a wheelchair cover having two covering members which cover the back and arms of the wheelchair and a third covering member to cover the cushion of the wheelchair. Among other difference, the multiple members disclosed in U.S. Pat. No. 7,278,649 do not provide the simple, inexpensive option that present invention allows.

U.S. Pat. No. 6,866,337 discloses a protective cover for a wheelchair also having two sections so that the cover wraps around the seat back of the wheelchair. This does not provide the low cost, identification and personalization option that the present invention allows.

U.S. Pat. No. 5,690,380 describes a one-piece slip cover optional trim component intended for lightweight folding or non-folding chairs. However, it has a loose draped appearance and does not allow for the simple decorative and personalization cover that the present invention allows.

Therefore, wheelchair users have a need for a very simple, low-cost decorative covering for the wheelchair back that is not allowed in the current state of the art.

### SUMMARY OF INVENTION

The invention is a practical and elegant way to provide a personalized covering on a wheelchair back and is useful for identification, aesthetic, messaging and marketing purposes. The decorative cover for a wheelchair back is simple, inexpensive and highly useful for the number of wheelchair users. The invention is a single cover that attaches to the back of the rear, upright panel of the wheelchair. The preferred embodiment of the disclosed cover comprises a single member or sheet made from a durable material that exhibits the necessary qualities and can be attached easily and snuggly to the back of a wheelchair without contacting a person sitting in the wheelchair. The upper portion of the cover mounts on the wheelchair with elastic loops that go over the wheelchair handles. The lower portion of the cover attaches to the wheelchair back's rails with two elastic extensions wherein the extensions are permanently fixed to the sheet at a first end and wherein the extensions have a second end that can be selectively coupled to the sheet so that the two extensions can create two loops when selectively coupled to the sheet. The second ends of the extensions can be selectively coupled to the sheet by means of VELCRO, snap buttons or other suitable fastening systems. The invention can be manufactured to the dimensions of any wheelchair back. The cover can be any color preferred by the user and can contain logos, designs, artwork, script, etc. as desired. Disclosed is a low-cost cover that can be used for identification and personalization of the user's wheelchair. The invention gives a wheelchair user a sense of identity that a run-of-the-mill wheelchair does not. It can make the user feel more comfortable with having to use a wheelchair and make the wheelchair user more approachable by non-wheelchair users in public. The invention may also be used in health care and corporate settings to assist with corporate branding, extend publicity or marketing initiatives or simply enhance the environment in which wheelchairs are made available.
A previously unknown need also exists for wheelchair users in that wheelchair users often desire a way to advertise an interest that the user might have. Such an advertisement provides the wheelchair user with a way to publicize areas of commonality that the wheelchair user might have with others. For example, on Honor Flights, some wheelchair users appreciate the opportunity to publicize the contribution the user may have made to their country with a detachable “bumper sticker” that can be placed on the back of the wheelchair, and the disclosed invention meets that previously unknown need.

### BRIEF DESCRIPTION OF DRAWINGS

The novel features believed to be characteristic of the present invention, together with further advantages thereof will be better understood from the following description and in connection with the accompanying drawings in which the preferred embodiment of the invention is illustrated by way of example. It is to be expressly understood, however, that the drawings are for the purpose of illustration and description only and are not intended as the definition of the limits of the invention.

FIG. 1 is an overhead view of the cover.

FIG. 2 is a view from behind the wheelchair with the cover fully installed on a wheelchair.

FIG. 3 is an overhead view of an alternative embodiment of the cover with a pocket.

FIG. 4 is a view of an alternative embodiment which has been folded to create the pocket.

FIG. 5 is a view of an alternative embodiment which has been sown to create the pocket.

FIG. 6 is a rear view of an alternative embodiment.

FIG. 7 is a rear view of an alternative embodiment fully installed on a wheelchair.

FIG. 8 is an overhead view of an alternative embodiment not installed

FIG. 9 is a rear view of the second alternative embodiment with the cover installed.

FIG. 10 shows the front of the second alternative embodiment with cover installed.

### DETAILED DESCRIPTION

The ensuing description provides exemplary embodiments only, and is not intended to limit the scope, applicability or configuration of the invention. Rather, the ensuing description of the exemplary embodiments will provide those skilled in the art with an enabling description for implementing the exemplary embodiments of the invention. It should be understood that various changes may be made in the function and arrangement of the elements without departing from the spirit and scope of the invention.

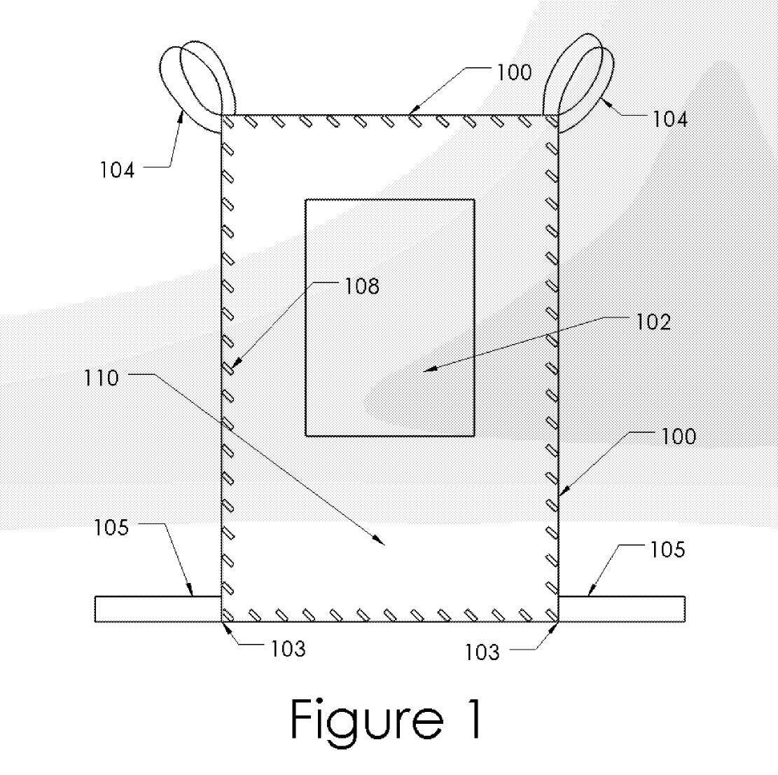

FIG. 1 shows the top view of the invention or part of the invention in a preferred embodiment. In this embodiment, the cover 100 is a single member that could be made from a variety of materials, each with different benefits and drawbacks. The material for the cover 100 is ideally durable and low cost (and should have other attributes disclosed later), but must also be capable of having logos and various designs printed onto the material. One embodiment will be made from a material that can accept inexpensive and practical means to apply logos and various designs, such as vinyl heat press. The front surface or first surface 110 should be the side of the cover that can accept the printed designs or logos. The front surface would be the surface that can be seen when a person is standing behind the wheelchair and facing the wheelchair. The design 102 can be accomplished by patterns in the material itself, embroidery, appliqué, heat transfer material or any other suitable means. Cotton, or other fibrous fabrics or synthetic fabrics or vinyl or another polymer such as polyester or rigid polymers such as hard plastics could be employed as the material for the cover. Polyester and more specifically denier polyester is an exemplary material that has a favorable balance of the mentioned benefits and drawbacks. 600×300 Denier polyester is a preferred material due to its durability and cost. The material might further be smooth on one side to mitigate against bacteria attaching to the cover. One material that accomplishes a favorable balance of the above mentioned tradeoffs is polyvinylchloride or PVC and can be used as a backing on denier polyester. The material could further be a specialized material that shows some resistance to bacteria. The material could have antimicrobial properties by containing an embedded material in trace amounts such as silver or other antimicrobial materials. The edges of the cover 100 should be finished with a seam 108 to eliminate frayed ends of the cover which can create unwanted attachment sites for bacteria. The seam is a surge seam in one embodiment. The invention can have a decorative design 102 on it that can take on any form within the confines of the cover. 600×300 denier polyester with PVC backing and surge seamed sides is a preferred material and configuration due to its balance of the aforementioned properties. In one embodiment, the edges 108 of 600 denier polyester with PVC backing of the cover are heat sealed seams.

The exemplary embodiment in FIG. 1 shows an area for a design 102 which would be visible on the rear of the wheelchair back. The design can personalize the wheelchair with, for instance, the user's name, favorite sports team, alma mater, marketing message, health awareness message, etc.

At the bottom two corners 103 of the cover 100 are two extensions 105 wherein the extensions are permanently fixed to the cover 100 at a first end that connects to a side of the cover near the corners 103 and wherein the extensions 105 have a second end furthest away from the cover 100. Some portion of the extension near the second end can be selectively coupled to the sheet or coupled to the extensions themselves closer to the cover 100 so that the two extensions can create two loops. The loops can be selective coupling means so that the extensions 105 can wrap around an attachment point on the wheelchair frame and reattach to the cover or the extensions themselves. The attachment point can be a post or bar on the frame. Generally, this post should not be more than three inches in diameter. A one inch diameter is more typical. The second ends of the extensions can be selectively coupled to the sheet by means of VELCRO, snap buttons, Sew-On elastic loop fasteners or other suitable fastening systems. The extensions are permanently fixed at the back side (second surface) of the cover so that the extensions do not overlap the first surface 110. The extensions can also be attached to the edges or the front side of the cover. The extensions 105 are ideally elastic to enhance the readability of the logo or design by allowing the cover to fit tight on various dimensions of wheelchair backs and the VELCRO is preferred to be over four inches long to accommodate the ideal range of wheelchair backs. Similarly, if snap buttons or some other connecting means are used, each side would be capable of accomplishing four inches of overlap. Two loops 104 should be made of elastic or any other suitable material and are permanently fixed to the back side of the cover near the top two corners. When the invention is installed on a wheelchair, these loops are placed over the chair handles 210 at the top of the chair and lowered down the rails to the top of the back panel of the wheelchair. In one embodiment, the loops 104 could be replaced by the extensions just like the lower extensions 105.

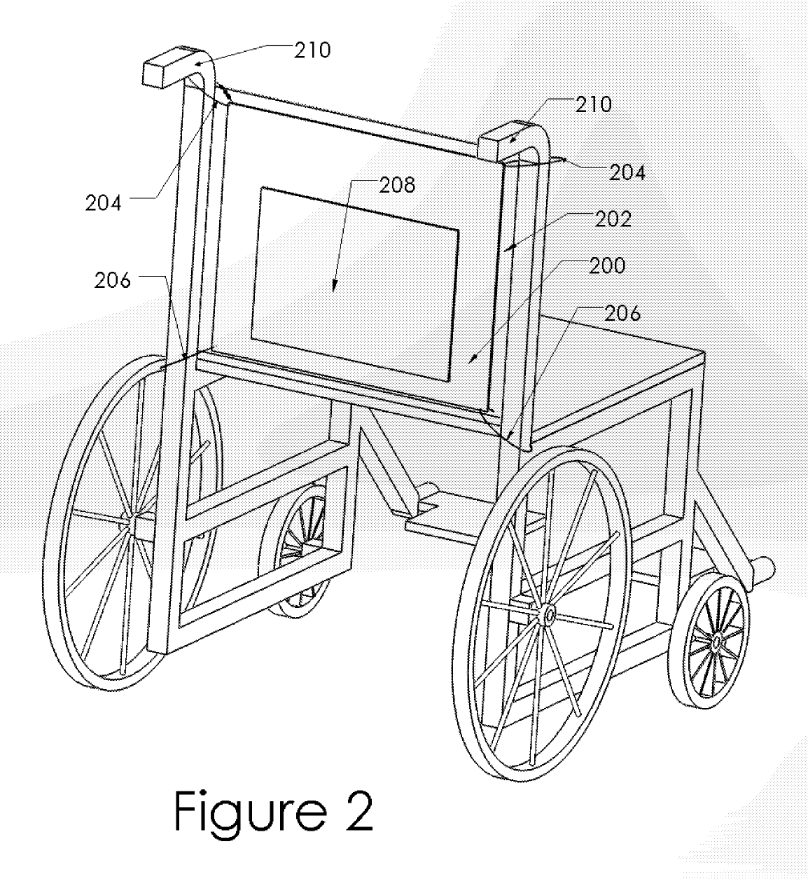

FIG. 2 shows a cover 200 fully installed on the seat back 202 of a wheelchair. The loops 204 are looped over handles 210 and placed immediately above the rear panel of the seat back 202. The extensions are shown wrapped around the wheelchair frame immediately next to the lower two corners of the cover 200. The extensions can be pulled tight to enhance the readability of the first surface of the cover 200. The area identified in FIG. 1 for decorative design 208 is shown. One preferred embodiment has margins that are over one inch between the sides of the cover 200 and the design for the ideal readability. In other embodiments, the design could be extended to the sides of the cover 200.

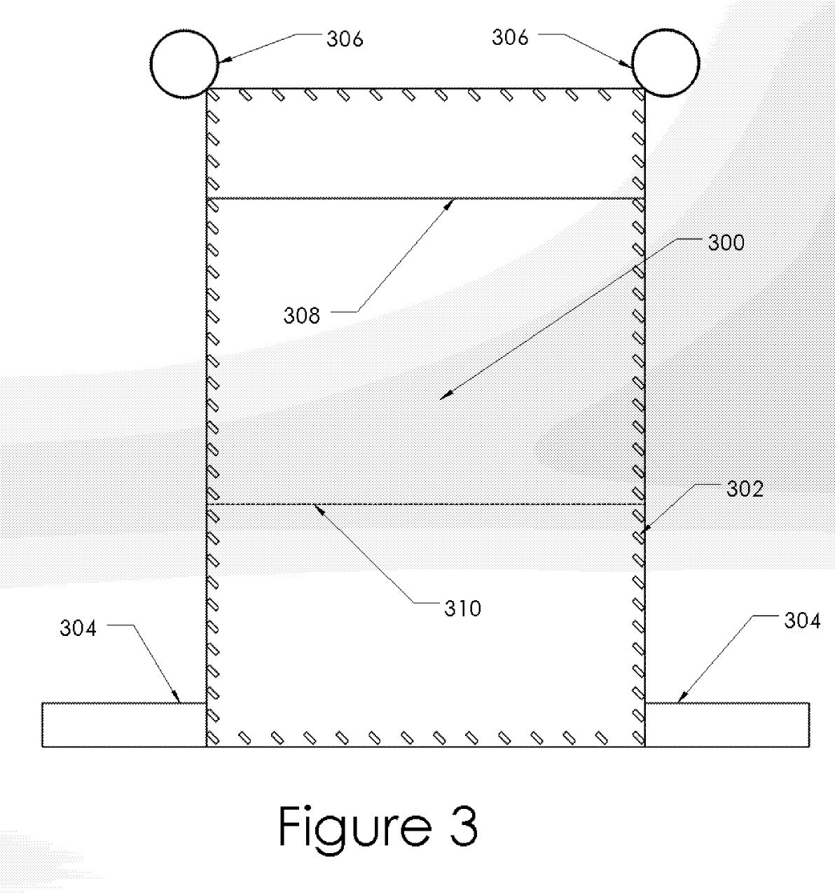

FIG. 3 shows an overhead view of an embodiment of the invention that can be used on a wheelchair with a pocket in the back panel of the wheelchair designed to carry medical records, personal belongings, etc. The cover 300 is a single member that has been folded to create pockets. The edges of the cover 300 can be finished with a seam 302 to eliminate fraying of the fabric. In one embodiment, the edges 108 of the cover are heat sealed seams. In one embodiment, the seams are surge seamed.

At the bottom two corners of the cover 300 are two extensions 304 wherein the extensions are permanently fixed to the sheet at a first end and wherein the extensions have a second end that extends away from the cover 300. The second end can be selectively coupled to the sheet so that the two extensions 304 can create two loops that selectively couple the sheet to posts on a wheelchair. The posts can be any bar or hook that could hold a loop. In one embodiment, the post will never be larger than three inches in diameter. The second end should selectively couple to the cover or to the extensions to create the loop. In a preferred embodiment, the extensions are elastic. The second ends of the extensions can be selectively coupled to the sheet by means of VELCRO, snap buttons, Sew-On elastic loop fasteners or other suitable fastening systems. The extensions may be sewn into the back side of the invention. The two loops may be made of elastic or any other suitable material 306 and are sewn on to the back side of the invention in the top two corners. When the invention is installed on a wheelchair, these loops are placed over the chair handles at the top of the chair and lowered down the rails to the top of the back panel of the wheelchair.

The top of the pocket 308 can receive items and the bottom of the pocket 310 prevents items from falling out of the pocket.

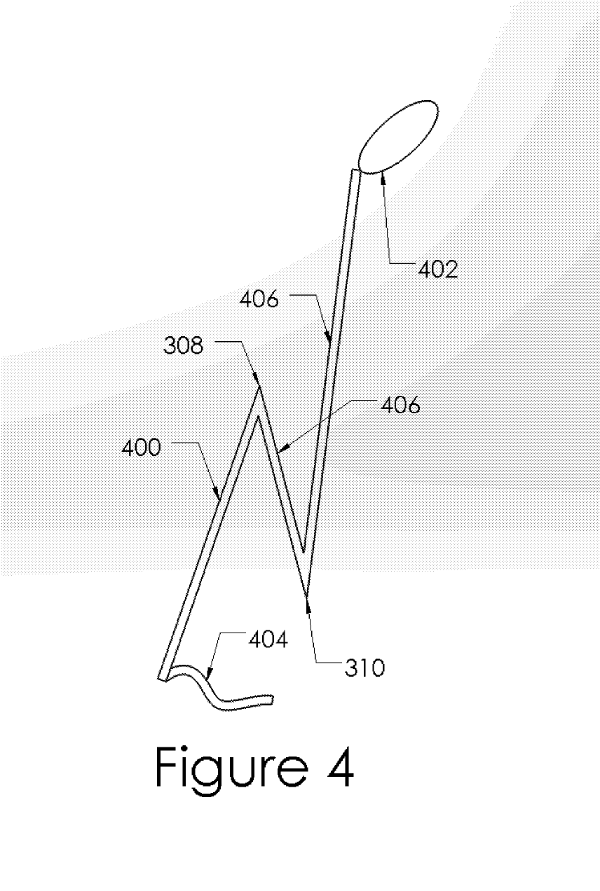

FIG. 4 shows the side view of an alternative embodiment of the invention. A pocket is incorporated that will slide down into the pocket in the rear panel of the wheelchair. A single piece of material 400 is folded as shown in the drawing creating the front and rear panels in the pocket 406. The extensions 402 and the extensions 404 are shown which are used to selectively couple the cover across the back of a seat back on a wheelchair.

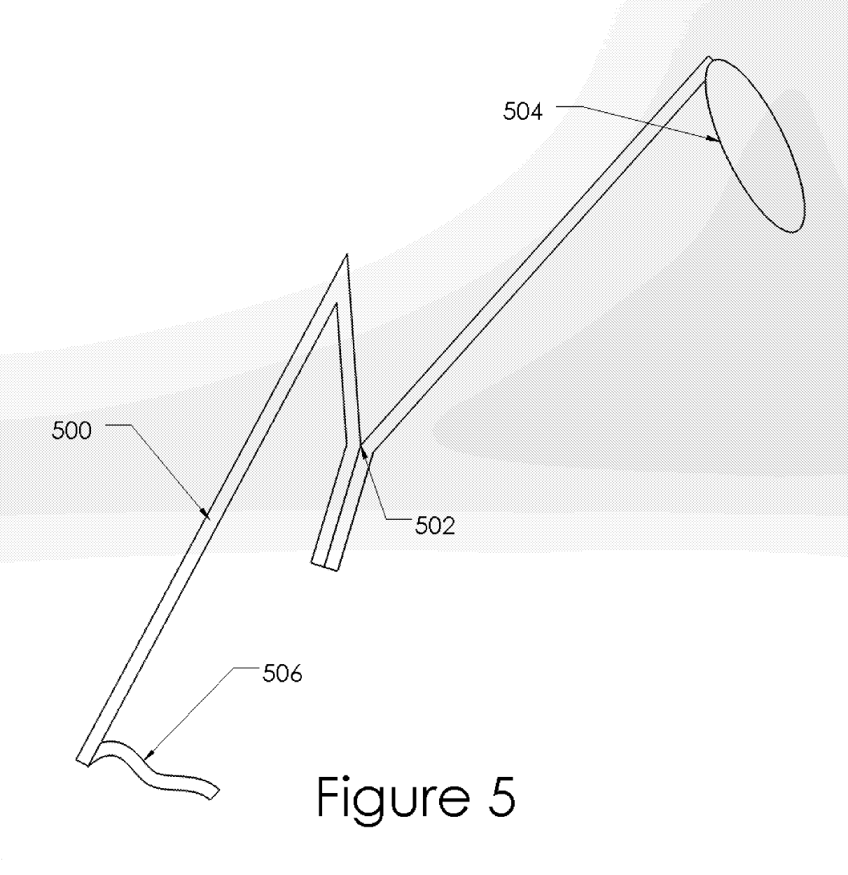

FIG. 5 shows another embodiment of a cover 500. The overlapping portions 502 closest to the rear panel of the wheelchair will be fixed together on the sides creating a pocket. The sides can be fixed together at some or all portions that make contact with each other. The sides can be sewn together. The attachment loops 504 and extensions 506 are shown.

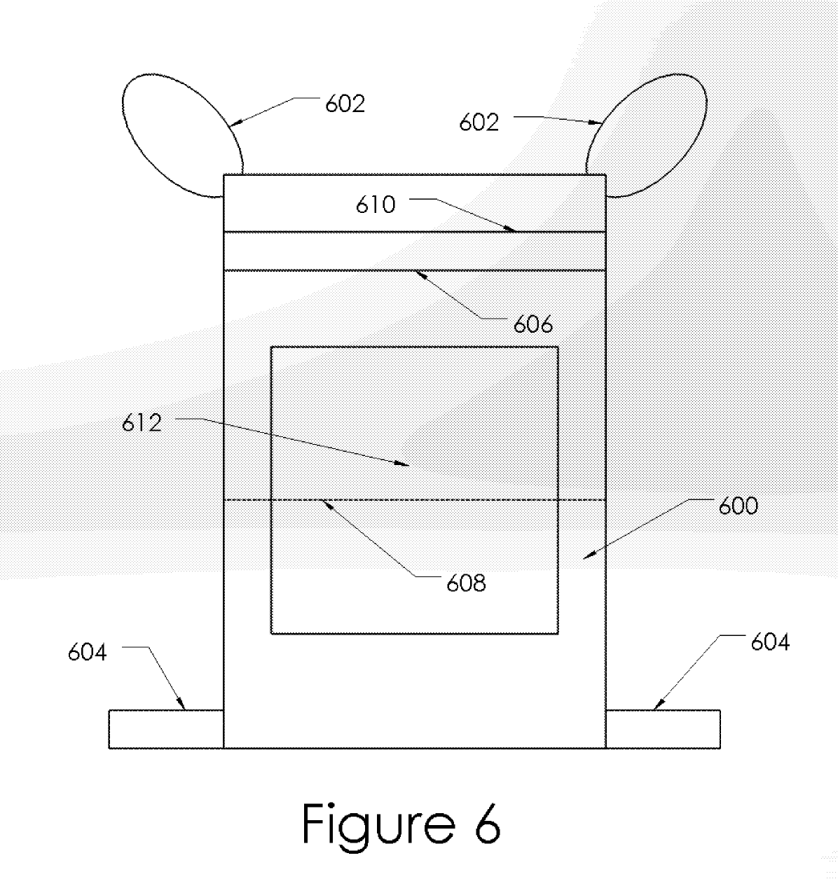

FIG. 6 shows the rear view of an alternative embodiment of the cover 600. The dotted line 608 depicts the bottom of the pocket 608 that will slide into the pocket on the rear panel of the wheelchair. The top or entry point to the pocket is shown 610. A control seam will be placed laterally on the fold of the outer two layers 606. The attachment loops 602 and extensions 604 are shown. The alternative embodiment of the invention can also have a decorative design on it. The design can be accomplished by patterns in the material itself, embroidery, appliqué, heat transfer material or any other suitable means. The alternative embodiment shows an area for a design 612 which would be visible on the rear of the wheelchair cover back. The design can personalize the wheelchair with, for instance, the user's name, favorite sports team, alma mater, marketing messages, etc.

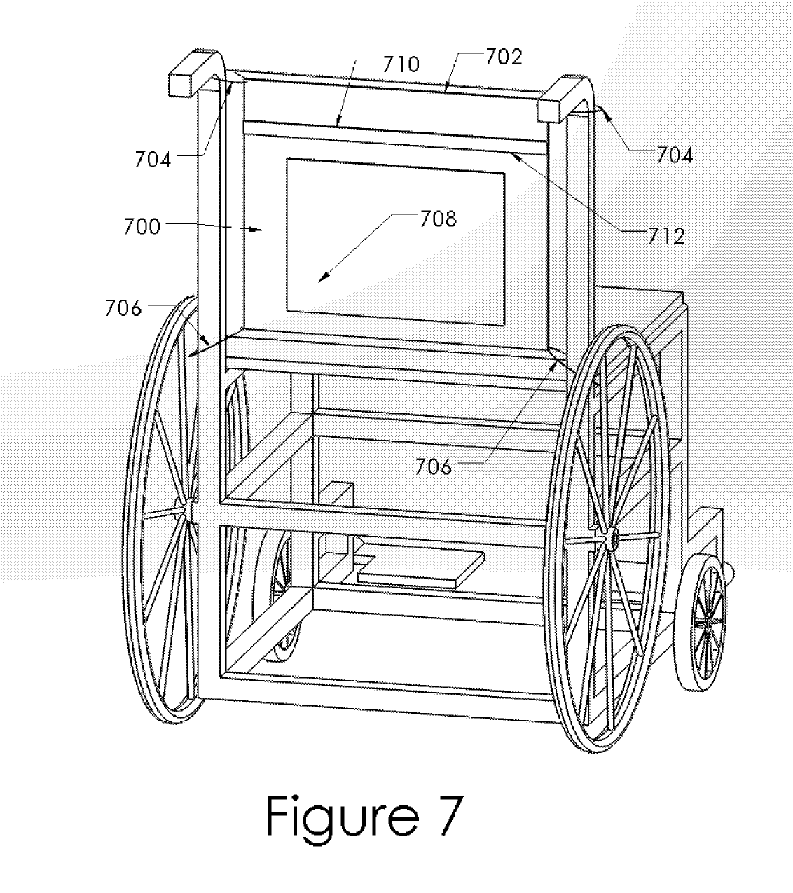

FIG. 7 shows the alternative embodiment of the invention 700 fully installed on the rear panel 702 of the wheelchair. The loops 704 are looped over the handles and placed immediately above the rear panel of the wheelchair 702. The extensions 706 have been sewn on the cover and are shown wrapped around an available attachment point on the wheelchair frame immediately next to the lower two corners of the cover 700. The ends of extensions are then selectively coupled to the cover to create a loop around an available attachment point on the wheelchair frame so that the cover 700 covers a substantial portion of the back of the wheelchair seat back. The area identified in FIG. 1 for decorative design 708 is shown. The top of the pocket 710 and control seam 712 are shown.

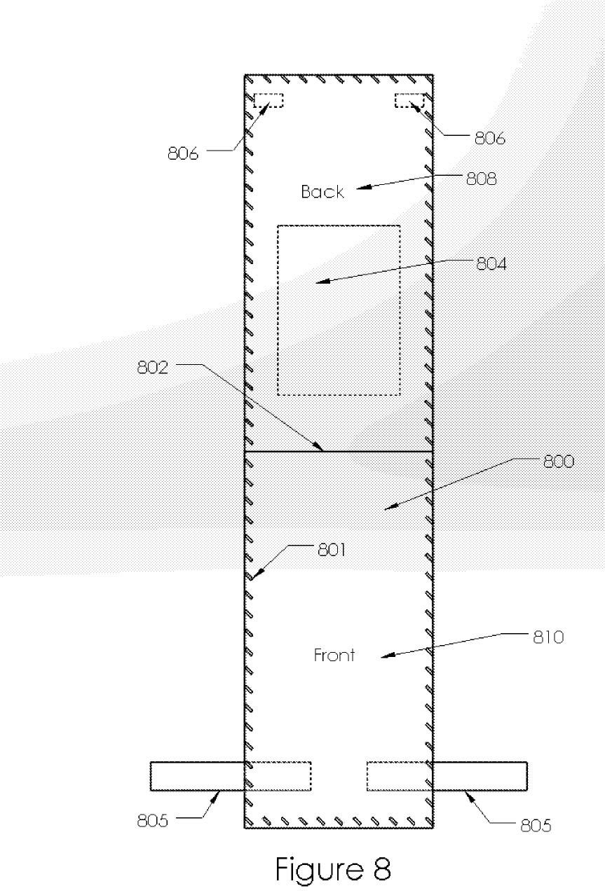

FIG. 8 shows an overhead view of another embodiment of the invention or part of the invention that can be applied to a different type of wheelchair. This embodiment is particularly designed for wheelchairs that do not have handles, such as sports wheelchairs and other custom made wheelchairs. FIG. 8 shows the overhead view of the cover where the cover is not installed on a wheelchair. The cover 800 is a single member made of a material. The cover folds into two halves and one half is the back 808 and the other half is the front 810. Each half has a first surface, that will be exposed and face away from the wheelchair seat back, and a second surface that will contact the wheelchair seat back.

The material should be durable and low cost, but also be capable of having logos and various designs printed on the first surface of the back 808. One embodiment will be made from a material that can accept inexpensive or other practical means to apply logos and various designs, such as vinyl heat press. The design can be accomplished by patterns in the material itself, embroidery, appliqué, heat transfer material or any other suitable means. In one embodiment, the material covering the front 810 should be a material that absorbs sweat. Cotton, or other fibrous fabrics or synthetic fabrics or vinyl are possible materials. The edges of the cover 800 should be finished with a seam 801 to eliminate fraying of the fabric. In one embodiment, the edges 108 of the cover are heat sealed seams. In one embodiment, the seams are surge seamed.

In one embodiment, the cover drapes over the front and back of the wheelchair back, and generally this is the embodiment that covers a wheelchair without handles for pushing. A control seam 802 is shown across the top of the cover. The control seam assists in proper installation and placement of the cover. The control seam allows the person installing the cover to know where the ideal point is to cover the top of the wheelchair seat back. The control seam could be a marker indicating the location of a crease that is intended to fit the top side of the seat back of the wheelchair. The control seam may be sewn across the top. In an ideal configuration the control seam 802 will be placed approximately one eighth inch from the fabric fold, to assist in proper installation and placement. The second alternative embodiment can have a decorative design 804 on it.

FIG. 8 shows an area for a design 804 which would be visible on the rear of the wheelchair back. The design can personalize the wheelchair with, for instance, the user's name, favorite sports team, alma mater, marketing message, health awareness message, etc.

At one side of the cover are two coupling members 805 used to selectively couple the cover to a seat back. On opposite side of the cover are two receiving points 806 which can be selectively connected to the coupling members 805. In one embodiment, the coupling members 805 are elastic extensions. The extensions could have VELCRO and could mate with two receiving points 806 that make up the mating side of VELCRO. The extensions could also connect to the receiving points by snap buttons, sew on elastic loop fasteners or other suitable fastening means. It should also be noted that the coupling members 805 do not need to be extensions, but could instead contain buttons or other suitable selective coupling means directly on the front half 810 and back half 806.

The extensions are permanently fixed to the cover. In one embodiment, the extensions are sewn into the second surface of the front half 810. As wheelchairs are manufactured to varying dimensions, customized covers will also vary in height and width dimensions. On higher back chairs, it may be necessary to place an additional set of selective coupling means between the bottom set of mechanisms and the control seam at the top of the cover.

The embodiment shown in FIG. 8 does not limit the invention to placing the extensions on the front half 810 and the receiving points 806 on the back half 808. These could be reversed, or extensions could make up the coupling members 805 and the receiving points 806. Or, as described earlier, both halves may not have extensions, but instead the front half 810 may be directly coupled to the back half 808 by placing the coupling members and the receiving points directly on the cover 800.

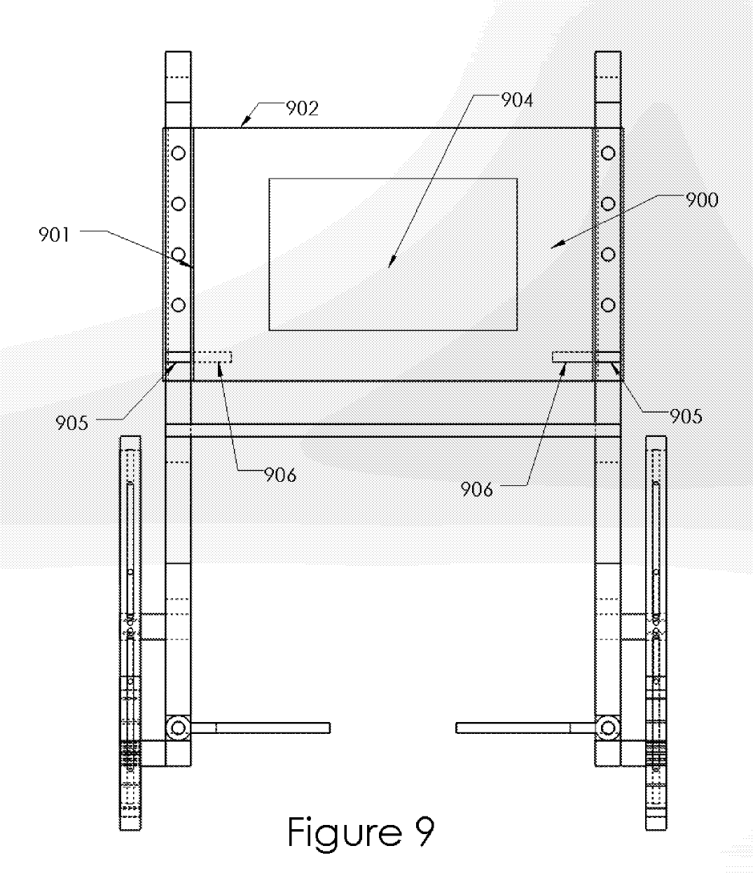

FIG. 9 shows the rear view of an embodiment with the cover installed on a wheelchair. The cover 900 is shown covering the back of the wheelchair seat back. The seam 901 is shown on the edges of the cover. In one embodiment, the edges 108 of the cover are heat sealed seams. In one embodiment, the seams are surge seamed. The control seam 902 is shown at the top of the cover resting directly on top of the top edge of the wheelchair seatback. An area for a design 904 which would be visible on the rear of the wheelchair back is shown. Two elastic extensions 905 that are permanently fastened to the front panel of the cover are shown wrapping around the wheelchair frame and fastened to the rear panel of the cover using a selective coupling means 906 such as VELCRO, snap buttons, Sew-On elastic loop fasteners or other suitable fastening systems.

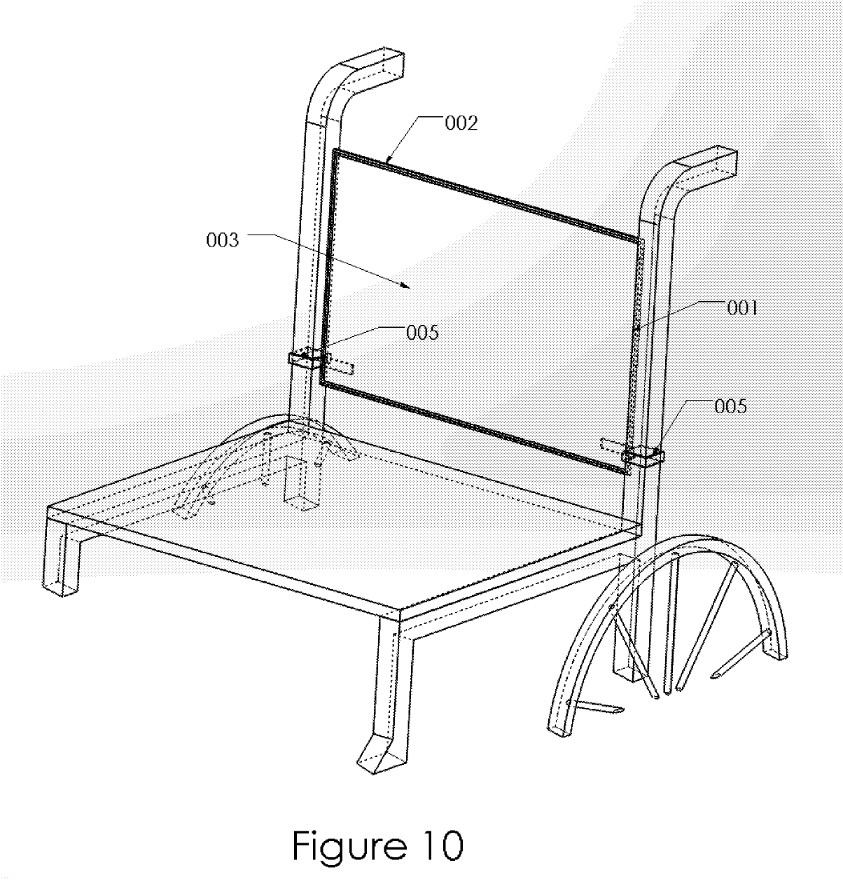

FIG. 10 shows the front of an embodiment with cover installed on a wheelchair. The cover 003 is shown covering the front of the wheelchair seatback. The seam 001 is shown on the edges of the cover. In one embodiment, the edges 108 of the cover are heat sealed seams. In one embodiment, the seams are surge seamed. The control seam 002 is shown at the top of the cover resting directly on top of the top edge of the wheelchair seatback. Two elastic extensions 005 that are permanently fastened to the front panel of the cover are shown wrapping around the wheelchair frame and fastened to the rear panel of the cover using a selective coupling means such VELCRO, snap buttons, Sew-On elastic loop fasteners or other suitable fastening systems.

The material for the sports wheelchair can be the same as for the more traditional wheelchair described in the first drawings. In some embodiments of the cover for the sports wheelchair, bacteria resistance is less important and sweat absorption and the ability to machine wash are more important.

We claim:

1. An apparatus comprising:
a wheelchair including
a seat and a seat back, the seat back having a front surface and a back surface joined by a first side and a second side, and a first vertical post and a second vertical post and wherein the first vertical post is disposed along the first side and the second vertical post is disposed along the second side and
a cover
having a top edge, a bottom edge, a first side edge and a second side edge, a first surface and a second surface
and plurality of coupling members extending outward from the edges
wherein the coupling members can loop around the first vertical post and the second vertical post so that the cover fits on the back surface of the seat back.

2. The apparatus of claim 1, wherein the first surface of the cover consists of a material that contains designs or logos on the first surface.

3. The apparatus of claim 1, wherein the cover consists of a material that can receive vinyl heat press for designs.

4. The apparatus of claim 1 wherein the coupling members consist of two loops and two extensions.

5. The apparatus of claim 1, wherein the coupling members consist of four extensions.

6. The apparatus of claim 4 wherein each of the two extensions have of a first end and a second end, and wherein the first ends are permanently coupled to the cover and wherein the second ends can be selectively coupled to the cover to create loops.

7. The apparatus of claim 5 wherein each of the four extensions have a first end and a second end, and wherein the first ends are permanently coupled to the cover and wherein the second ends can be selectively coupled to the cover to create loops.

8. The apparatus of claim 6 wherein the second ends are selectively coupled to the cover by means of VELCRO that connect the second ends to the cover.

9. The apparatus of claim 6 wherein the second ends are selectively coupled to the cover by means of snap buttons that connect the second ends to the cover.

10. The apparatus of claim 7 wherein the second ends are selectively coupled to the cover by means of VELCRO that connect the second ends to the cover.

11. The apparatus of claim 4 wherein the two loops are sized so that they will not fit around a circular post that is more than 3″ in diameter.

12. The apparatus of claim 1 wherein the material for the cover is denier polyester with PVC backing.

13. The apparatus of claim 1 wherein the coupling members are made of elastic material.

14. The apparatus of claim 1 wherein the edges of the cover are surge seamed.

15. The apparatus of claim 1, wherein the cover has a pouch for carrying items.

16. The apparatus of claim 1, wherein the cover and coupling members are made of a bacteria resistant material.

17. The method of claim 12, wherein the cover is fit tight to the seat back.

18. A method for using a wheelchair and sign apparatus comprising:
Placing a cover having a top edge, a bottom edge, a first side edge, a second side edge, a first surface and a second surface with a logo on the first surface adjacent to a seat back of a wheelchair wherein the seat back of has a front surface and a back surface and two vertical posts to support handles for pushing the wheelchair and
attaching coupling members connected to the cover to the handles or the two vertical posts in a manner that prevents any of the cover or coupling members from contacting the front surface of the seat back.

19. The method of claim 18, wherein at least some of the coupling members are fixed loops that go over the handles.

20. An apparatus comprising:
a wheelchair including
a seat and a seat back, the seat back having a front surface and a back surface joined by a first side and a second side and
a cover
having a top edge, a bottom edge, a first side edge and a second side edge, a first top corner and a second top corner and a first surface and a second surface and
a crease through the middle running parallel to the top edge and bottom edge two extensions each having a first end and a second end wherein a first extension extends outward from the first side edge and a second extension extends outward from the second side edge end wherein each first end is permanently attached to the cover and each second end can be selectively coupled to create loops
wherein the cover hides at least part of the back surface of the seat back and
wherein the cover is made of a material that is capable of accepting designs applied with vinyl heat press.
